(19) United States
(12) Patent Application Publication
(10) Pub. No.: US 2002/0018570 A1
(43) Pub. Date: Feb. 14, 2002

(54) System and method for secure comparison of a common secret of communicating devices

(75) Inventors: Uwe Hansmann, Altdorf (DE); Lothar Merk, Weil A. Schoenbuch (DE); Martin Scott Nicklous, Stuttgart (DE); Thomas Stober, Boeblingen (DE)

Correspondence Address: WILLIAM KINNAMAN, JR., IBM Corporation, Intellectual Property Law Department, 2455 South Road, M/S P386, Poughkeepsie, NY, 12601, US

(73) Assignee: INTERNATIONAL BUSINESS MACHINES CORPORATION, ARMONK, NY (US)

(21) Appl. No.: 09/900,637

(22) Filed: Jul. 6, 2001

(30) Foreign Application Priority Data
Jul. 7, 2000 (DE) 00114612.5

(51) Int. Cl. H04K 1/00

(52) U.S. Cl. 380/270

(57) ABSTRACT

A simplified authentication system for communicating devices having fewer security requirements than conventional cryptographic systems. The device to be authenticated includes a secret, a function component for generating a random number, a function component for exchanging messages with other devices and finally an algorithm for calculating a hash using random number and secret. The device requesting authentication includes a secret and an algorithm for calculating a hash using a random number received from the device to be authenticated. A function component for comparing both hashes may be implemented in both devices. If the hashes calculated by both devices match it can be assumed that the authentication was successful. Preferably, this system and method may be used within a communication structure using portable communication devices like smartcards, personal digital assistants or mobile phones. Neither an exchange of the plain secret itself nor the storage of digital keys is required. A misuse of the secret may be excluded by sending a hash using the random number and the secret. The infrastructure required by the present invention is very simple and does not consume storage capacity like conventional encryption methods, since digital keys and conventional symmetric or asymmetric algorithms are not required. Instead of using the digital keys and conventional symmetric or asymmetric algorithms, the present invention contemplates using a relatively simple random number and a simple hash algorithm, which sufficiently fulfills the security requirements of many communication architectures.

### BACKGROUND OF THE INVENTION

1. Field of the Invention

The present invention relates to a system and method for secure comparison of a common secret of communicating devices, more particularly, to prove the authenticity of communicating devices within a client-server architecture using a common secret shared by client and server.

2. Description of the Related Art

Normally, authentication is required to work with a remote server, to access data on a server, or to use a private network. The authentication can go in two directions. Either the server needs to prove its authenticity to the client, or the client needs to prove its authenticity to the server, or both.

Therefore, either the server, or the client, or both must securely keep a private key. For the client key the portable smart card is ideal. It can securely store the private key and execute the required cryptographic algorithms with it.

The most important smartcard cryptographic protocols for authenticating devices are external and internal authentication.

External authentication means the authentication of an external device to the smartcard. The smartcard and the external device conduct a challenge-response protocol as follows:

1. The external device requests a random number from the smartcard by sending an appropriate command to the smartcard.

2. The smartcard creates a random number and returns it in the response to the external device.

3. The external device uses a cryptographic key corresponding to the cryptographic key in the smartcard to encrypt the random number. It sends an authentication command containing the encrypted random number to the smartcard.

4. The smartcard receives the authentication command and decrypts the encrypted random number. If the result is equal to the stored random number, the smartcard assumes that the external device is authentic.

The cryptographic algorithms used for external authentication may be symmetric or asymmetric like DES or RSA.

Internal authentication means the authentication of a smartcard to an external device. The smartcard and the external device conduct a communication protocol as follows:

1. The external device sends an authentication command containing a random number and the key number for specifying the key to be used by the smartcard.

2. The smartcard encrypts the random number received from the external device using the authentication key with the number specified in the message of the external device and sends back the encrypted random number.

3. The external device decrypts the encrypted random number using the cryptographic key corresponding to the cryptographic key that has been used in the smartcard. If the result is equal the external device assumes that the smart card is authentic.

If a symmetric algorithm has been used, the external device and the smartcard must share a common secret.

If an asymmetric algorithm is used, the external device uses a public key and the smartcard uses the corresponding private key.

Symmetric cryptographic algorithms are fast and can be used to encrypt and decrypt large amounts of data. However, the fact that the same key has to be used for encryption and decryption causes a problem when symmetric algorithms are to be used to ensure privacy of communication. The sender and receiver of a message must use the same key. Each receiver must know the keys of all potential senders to be able to decrypt all incoming messages.

The most famous asymmetric cryptographic algorithms are the public-key algorithms. Many public-key algorithms have been proposed, most of them insecure or impractical. The well-known RSA algorithm, for example, takes about 1000 times longer than DES when implemented in software or about 100 times longer than DES when implemented in hardware.

Public-key algorithms use different keys for encryption and decryption. The private key may only be known to its owner and must be kept secret (smart card). It may be used for digital signature or for decrypting private information encrypted under the public key. The public key may be used for verifying a digital signature or for encrypting information. It does not need to be kept secret because it is infeasible to compute the private key from a given public key.

Normally smartcards are ideal for storing secrets. However, a disadvantage of smartcards is their reduced storage capacity for storing cryptographic algorithms and digital keys, especially of storage-consuming algorithms like DES or RSA. Furthermore, storing keys in the smartcard in a secure way without allowing misuse of keys and administering the keys by so-called trust centers require an expensive and complicated infrastructure.

Finally, smartcards using cryptographic algorithms like DES or RSA are controlled by national export regulations.

It is therefore an object of the present invention to provide a simplified and less storage consuming system and method for authentication between communicating devices having a common secret without exchanging the secret itself.

This object has been solved by the features of the independent claims. Further embodiments of the present invention are laid down in the subclaims.

### SUMMARY OF THE INVENTION

The present invention relates to a simplified authentication system for communicating devices having fewer security requirements than conventional cryptographic systems.

The device to be authenticated includes at least a secret, a function component for generating a random number, a function component for exchanging messages with other devices and finally an algorithm for calculating a hash using the random number and the secret. The device requesting authentication includes a secret and an algorithm for calculating a hash using the random number received from the device to be authenticated. A function component for comparing both hashes may be implemented in both systems. If the hashes calculated by both devices match it can be assumed that the authentication was successful.

This system and method may be used preferably within a communication structure using portable communication devices like smartcards, personal digital assistants or mobile phones.

Neither an exchange of the plain secret itself nor the storage of digital keys is required. A misuse of the secret may be excluded by sending a hash using a random number and the secret. The infrastructure required by the present invention is very simple and does not consume storage capacity like conventional encryption methods, since digital keys and conventional symmetric or asymmetric algorithms are not required. Instead of using the digital keys and conventional symmetric or asymmetric algorithms, the present invention contemplates using a relatively simple random number and a simple hash algorithm which sufficiently fulfills the security requirements of many communication architectures.

### BRIEF DESCRIPTION OF THE DRAWINGS

The present invention will be better understood and its numerous advantages will become apparent to those skilled in the art by reference to the following drawings, in accordance with the accompanying specification, in which:

FIG. 1 is a generalized view of the components of the present invention;

FIG. 2 shows an implementation of the present invention in an e-commerce environment;

FIG. 3 shows an implementation of the present invention in a LAN environment,

FIG. 4 shows the method of the present invention.

### DESCRIPTION OF THE PREFERRED EMBODIMENT

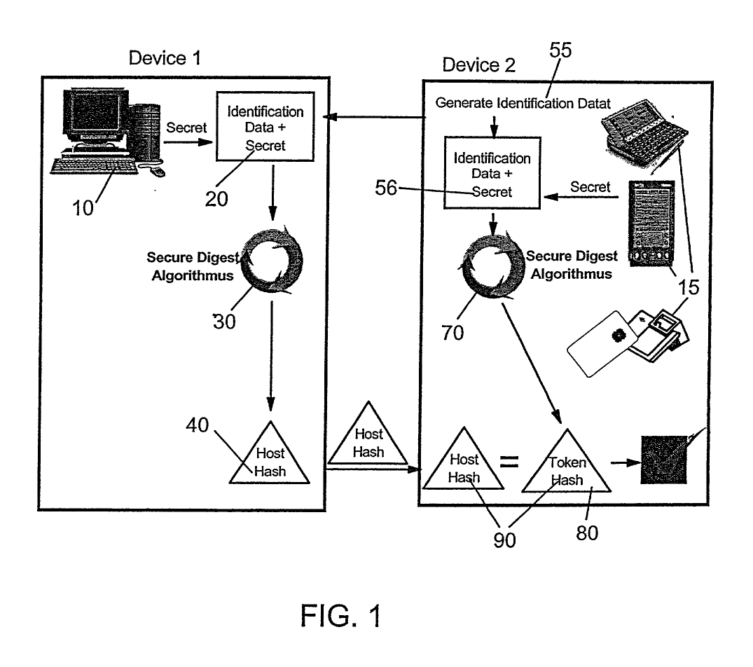

FIG. 1 shows the basic components of the present invention.

The present invention may be implemented in any communication architecture having at least a sender device 15 and a receiver device 10 communicating via a wired or wireless network (e.g., a LAN or the Internet). A communication between sender 15 and receiver device 10 may only be established if an authentication protocol has been successfully executed. Sender device 15, which needs to be authenticated, may be any portable or non-portable device either having a lesser storage capacity or not requiring a conventional authentication system with a complex infrastructure. Receiver device 10 may be a any device offering services to the sender device 15 if the authentication succeeds. Preferably, receiver device 10 is a banking terminal, an automatic teller machine or a Web server offering e-commerce applications.

Sender device 15 (Device 2) includes a secret 56, which is identical with a secret 20 of the receiver device 10 and an algorithm 70 for calculating a hash 80 which is identical with the hash algorithm 30 of the receiver device 10. For example, the secret may be stored in a security module or a smart card belonging to the sending device.

Sender's hash algorithm 70 uses the secret 56 stored in the sender device 15 and identification data 55 generated by the sender device 15. Preferably, the secret 56 is a password or a PIN. Finally, sender device 15 includes a comparing component 90 comparing hashes 80 of the sender 15 as well as the receiver device 10. In a preferred embodiment, sender's secret 56, sender's hash algorithm 70 and comparing component 90 are stored in a smartcard. Access to the smartcard is made via a card reader which may be part of the sender device or a separate card reader connected with the sender device. Furthermore, sender device 15 includes a software component for generating identification data 55, e.g., a random number. The identification data 55 is generated when executing an authentication protocol and is sent to the receiver device 10.

Receiver device 10 (Device 1) includes a secret 20 and an algorithm for calculating a hash 30 using identification data 55 generated by the sender device 15 and the PIN or password 20, 56 shared by the sender and receiver device. For example, the secret may stored in a secure environment. Optionally, receiver 10 may also include a comparing component (not shown) for comparing the hashes generated by sender 15 and receiver device 10. In a further embodiment, secret 20 of the receiver device 10, receiver hash algorithm 30 and, if available, a comparing component may also be stored in a smartcard.

In a further embodiment, each communication device 15, 10 has its own component 90 for comparing the hashes as well as its own component for generating random numbers 55. This embodiment will be preferably used in a communication architecture in which both communication devices must be able to initiate an authentication process.

Assuming that the sender device 15 is a card reader in which a smartcard is inserted and the receiver device 10 is an automatic teller machine, the method for accessing the automatic teller machine is as follows:

1. Terminal/card reader 15 initiates an authentication protocol sending a customer ID to the automatic teller machine 10.

2. Automatic teller machine 10 determines the PIN 20 associated with that customer using the customer ID.

3. Component 55 for generating a random number, which is part of the card reader or smartcard 15, generates a random number and sends it to the automatic teller machine 10.

4. Hash algorithm 30, 70 of the automatic teller machine 10 and card reader/smartcard 15 generates a hash 40, 80 using the customer PIN 20, 56 and the random number 55.

5. Hash 40 of the automatic teller machine 10 is sent to the card reader/smartcard 15.

6. Component 90 for comparing the hashes 40, 80, which is part of the card reader/smart card 15, compares both hashes. If the hashes are equal, access to the automatic teller machine is allowed.

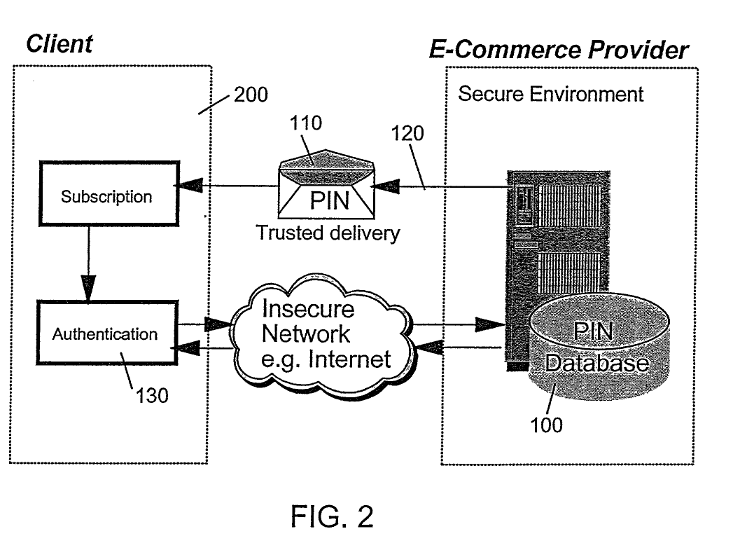

FIG. 2 shows an example of an e-commerce environment in which the present invention may be used.

The e-commerce provider offers e-commerce applications via a server 100. A potential customer may receive a password 110 from the e-commerce provider via a secure transmission channel 120, e.g. by trusted delivery.

If the customer wants access to the e-commerce application he needs a password or PIN for accessing the e-commerce application. The plain password could be sent from the customer communication device (client 200) via the Internet to the server 100 of the e-commerce provider, however, taking the risk that misuse of the password/PIN is possible. To avoid such misuse, conventional cryptographic algorithms are currently used with the consequence that an enormous cryptographic infrastructure is required.

That means, in detail, that digital keys in the size of 1024 or more bits and storage-consuming cryptographic algorithms are required. Digital keys of that size are not perceptible by a customer.

Using the present invention, no digital keys as used by standard cryptographic systems are required, only passwords or PINs having a small size of 8 bytes. Such passwords are easily perceptible by the customer. The PIN or password does not leave the devices in its plain format. No key distribution (e.g., for symmetric cryptographic algorithms) is required. Furthermore, the hash algorithm used by the present invention is simple and does not require an enormous cryptographic infrastructure like conventional prior art security systems requiring complex cryptographic algorithms. Preferably a secure hash algorithm is used.

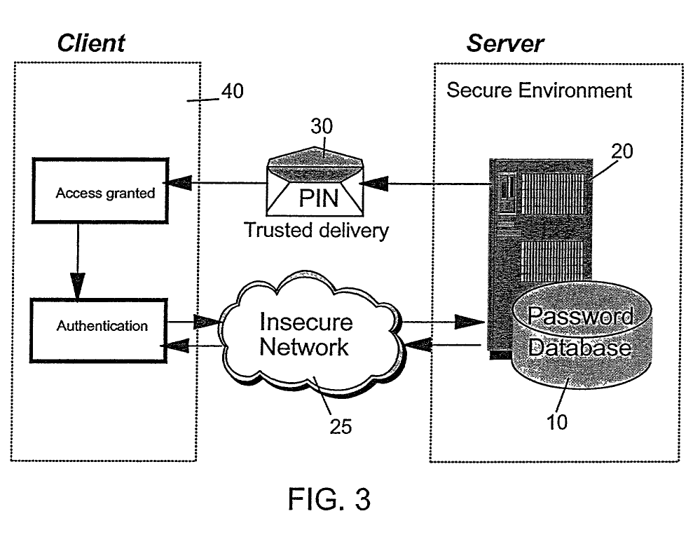

FIG. 3 shows an example of a LAN-environment in which the present invention may be preferably used. Shown is a typical client-server architecture. Client 40 and server 20 communicates via a insecure network 25. PIN 30 will be provided to the client 40, e.g. by a trusted delivery. The client 40 generates a random number and sends it to the server 20. On the server 20 and the client 40, identical random numbers and identical PINs are provided to the hash algorithm for generating a hash. On the client side 40 a comparison of both hashes is accomplished. If both hashes are equal, access to the server is allowed.

Preferably, the client's hash algorithm and the client's secret are stored in a security module of a smartcard. The smartcard is inserted in a card reader communicating with the server 20.

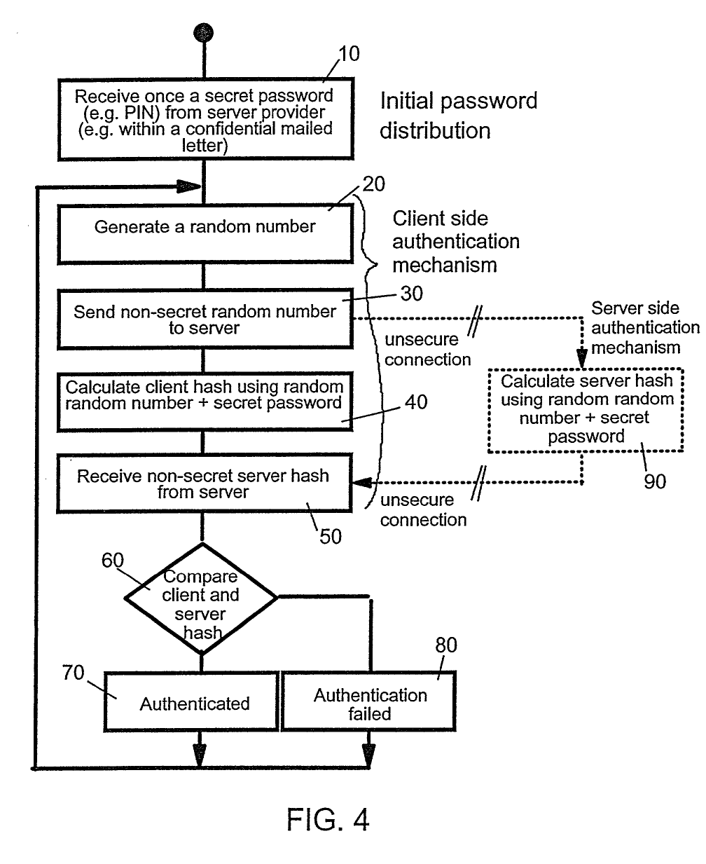

FIG. 4 shows the inventive method in a client-server architecture as shown in FIG. 3.

A server may receive a password or PIN from the server provider via a secure connection, e.g. by trusted delivery (step 10). A client opens a session with the server, then generates a non-secret random number (step 20) and sends it to the server (step 30) via an insecure connection. The client's hash algorithm (step 40) and the server's hash algorithm (step 90) calculate a hash using a common random number and common PIN. The server sends the hash calculated via the insecure connection to the client (step 50). On the client side both hashes will be compared (step 60). If both hashes are equal, authentication is successful (step 70); if the hashes are unequal, the authentication is failed (step 80).

What is claimed is:

1. A method for authentication of communicating devices having a common secret, said method comprising the steps of:
receiving a hash by a receiving device from a sending device; and
comparing said hash received from said sending device with a hash of said receiving device, wherein both hashes are calculated by hash algorithms using identification data and said common secret.

2. The method of claim 1 wherein said identification data is generated by said sending device.

3. The method of claim 2 wherein said identification data is sent from said sending device to said receiving device.

4. The method of claim 1 wherein said hash algorithms are identical.

5. The method of claim 1 wherein said common secret comprises a PIN.

6. The method of claim 1 wherein said common secret comprises a password.

7. The method of claim 1 wherein said identification data is a random number.

8. The method of claim 7 wherein said random number is generated by an operating system of said sending device.

9. The method of claim 7 wherein said random number is generated by a separate software component which is part of said sending device.

10. The method of claim 1 wherein said comparing step is accomplished by said sending device.

11. The method of claim 1 wherein said comparing step is accomplished by said receiving device.

12. The method of claim 1 wherein said common secret, said hash algorithm and said comparing component of said sending device are stored in a smartcard and communication between smartcard and receiving device is established via a card reader.

13. The method of claim 12 wherein said smartcard and said card reader are part of a portable sending device.

14. The method of claim 1 wherein the data connection between the sending device and the receiving device is an insecure data connection.

15. The method of claim 1 wherein said sending device and said receiving device form a client-server architecture.

16. The method of claim 1 wherein said client is a portable device.

17. A client in a client-server architecture having an authentication system for executing the method of claim 1.

18. A server in a client-server architecture having an authentication system for executing the method of claim 1.

19. A sender device communicating with a receiver device, wherein one or both of said sender device and said receiver device comprise an authentication system for executing the method of claim 1.

20. A computer program product stored on a computer-readable medium containing software code for performing the method of claim 1 if the program product is executed on the computer.
